(19) United States
(12) Patent Application Publication
(10) Pub. No.: US 2010/0042600 A1
(43) Pub. Date: Feb. 18, 2010

(54) ROLE-BASED CONTACT LIST MANAGER

(76) Inventors: Robert L. Orr, Raleigh, NC (US); Douglas A. Wood, Raleigh, NC (US); Kamorudeen Larry Yusuf, Hampshire (GB)

Correspondence Address: HOLMAN IP LAW/IBM RSW, 175 S Main Street, Suite #850, Salt Lake City, UT, 84111, US

(21) Appl. No.: 12/190,843

(22) Filed: Aug. 13, 2008

(51) Int. Cl. G06F 17/30

(52) U.S. Cl. 707/4; 707/E17.001

(57) ABSTRACT

A system and method for managing a contact list within a business process automation tool. The method includes identifying an active task of a user within the business process automation tool. The method also includes identifying a plurality of roles associated with the active task. Each of the roles is associated with corresponding contact information. The method also includes generating a contact list of the roles and the corresponding contact information.

### BACKGROUND

In an enterprise context, people often need to communicate with others. Conventional electronic communication media include voice and text chat, as well as email. Traditional chat systems use a list of contacts which allow a user to find someone by that person's name. To communicate with a person, the person's contact information is located and communication is established. Locating the contact information for a person with whom communication is desired can be time consuming, especially when the exact name of the person is not known.

Current solutions for contact list management are either manual or partially automated by performing a harvesting operation to identify user names based on a communication artifact such as a meeting invitation, email, or web meeting information. In current practice, the user determines the name of the person who fills a particular role, and then the user performs a directory look-up to establish communication with that person. In an enterprise context, people often collaborate with others based on project roles, rather than names or personal relationships. In other words, the collaboration is often based on the organizational or task roles of the contacts.

Identifying the correct person for a particular role can be difficult if the collaboration context varies in the same role or different roles over time. Additionally, a contact may be involved with a single project or several projects. Current solutions for identifying people based on their role involve compiling static contact lists which are often very extensive, and searching the contact lists for the name of a desired contact.

### SUMMARY

Embodiments of an apparatus are described. In one embodiment, the apparatus is a computer program product including a computer useable storage medium to store a computer readable program that, when executed on a computer, causes the computer to perform operations. In one embodiment, the operations include an operation to identify an active task of a user within a business process automation tool. The operations also include an operation to identify a plurality of roles associated with the active task. Each of the roles is associated with corresponding contact information. The operations also include an operation to present a contact list of the roles and the corresponding contact information to the user. Other embodiments of the apparatus are also described.

Embodiments of a system are also described. In one embodiment, the system includes a computer, a business process automation tool, and a role-based contact manager. The business process automation tool is stored and configured to operate on the computer. The business process automation tool manages a business process. The role-based contact manager is coupled to the business process automation tool. The role-based contact manager identifies a plurality of roles associated with an active task within the business process automation tool. Each of the roles is associated with corresponding contact information. The role-based contact manager also generates a contact list of the roles and the corresponding contact information. Other embodiments of the system are also described.

Embodiments of a method are also described. In one embodiment, the method is a contact list management method. The method includes identifying an active task of a user within a business process automation tool. The method also includes identifying a plurality of roles associated with the active task. Each of the roles is associated with corresponding contact information. The method also includes generating a contact list of the roles and the corresponding contact information. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE SEVERAL VIEWS OF THE DRAWINGS

FIG. 1 depicts a block diagram of one embodiment of a network to automate a business process.

FIG. 2 depicts a block diagram of one embodiment of a business process automation system for implementation on the network of FIG. 1.

FIG. 3 depicts a block diagram of one embodiment of the role-based contact manager of the business process automation tool of FIG. 2.

FIG. 4 depicts a block diagram of one embodiment of a role/user identification engine of the role-based contact manager of FIG. 3.

FIG. 5 depicts a block diagram of one embodiment of the learning engine of the role-based contact manager of FIG. 3.

FIG. 6 depicts one embodiment of the user registry of the business process automation tool of FIG. 2.

FIG. 7 depicts a schematic diagram of one embodiment of a user interface for implementation with the business process automation tool of FIG. 2.

FIG. 8 depicts a flow chart diagram of a contact list management method for implementation with the business process automation tool of FIG. 2.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments facilitate the addition of instant messaging (IM) contact list management into a business process automation tool such as Maximo®. The contact list management system manages a contact list based on active task in the process management environment. In some embodiments, the contact list is built based on the roles and interested parties for the current task and changes dynamically with both the state of the task and the active task. The contact list manager also includes a learning algorithm that controls display order within the contact list and can move frequently used contacts into more permanent sections of the task list. The contact list manager also may implement the learning algorithm to age out unused or less frequent contacts.

In the business world, many interactions are ephemeral and based on current task context. A simple example of this is a purchasing agent processing a purchase order (P.O.). During the processing of a P.O., the purchasing agent may communicate with one or more of the approvers, or the submitter. The purchasing agent may not know the name or contact information of the person who fills the approver's role. Thus, the purchasing agent needs to communicate with a role, such as a “Division Approver.” In current practice, the purchasing agent determines the person filling the role and then performs some type of a directory look-up to obtain that person's contact information, for example, in order to establish a chat channel.

The conventional process can be improved if the application managing the purchase order task understands the current task and task context. In one embodiment, the managing application can dynamically manage a contact list of interested parties. The list may be assembled based on the current task in the process flow, and the tree of related objects. Contacts may be organized by role and displayed with the task and organizational tags, as well as an explanation based on the context of how the contact is relevant to the current task.

An example listing in the contact list could be:
Ron Smith
Manufacturing Division CFO
Required Approver (P.O. exceeds $1,000,000)

As one example of an interface to facilitate automatic generation of contact information for roles associated with a task in a business process, assume a purchasing agent selects vendors to fill an order for server hardware. The purchasing agent might see on the active tab of a user interface a list of representatives for vendors approved to supply the requested equipment. In one embodiment, a second tab of the user interface may display financial approvers, for example, with a list of all the approvers and the P.O. A third tab might have interested parties drawn from the business proposal that generated the P.O. A fourth tab might have implementers drawn from the change request to install the hardware.

In one embodiment, the interface for contact management is implemented by using an active process artifact in a workflow/process management system such as Maximo® to provide the base task context. In general, a business process management system is a computer program that manages user-filled forms and executes business logic for workflows based on the state of the forms or other current tasks. Examples of a process management tool include purchasing systems, enrollment of booking systems, and service desk automation tools. The interface for contact management also might use the user's role in relationship to both the process and the active task to provide secondary context. In one embodiment, any contact named directly in the process artifact is a first order candidate for the contact list. Role information may be determined based on the field in which the name appears. In one embodiment, second order candidates for the contact list are derived by examining related and auxiliary process artifacts. Examples of these types of objects include a task to implement a work order and a change request linked to an incident as either the cause or the resolution. In general, inclusions of second order objects are filtered by rules supplied by the process designer. The rules are driven by the current process state, type, and relationship of secondary objects, and the role of the potential contact. In addition, any field that can contain a user name in a process artifact can be tagged with metadata to refine its context for context management. The tags can also be referenced in the rules. Third order candidates for the contact list may be derived from analyzing workflow processes that drive the active processes for names and roles. In any of the above cases, it may be possible to perform a role-based lookup to resolve a role reference in the process artifact of an actual contact. It is also possible for the contact resulting from a role to be a group queue or a bot.

In some cases, user rights are applied to the contact harvesting process so contacts are displayed from fields to which the users are read access. In other cases, additional display information can be retrieved from user registries to enrich the contact list. Enriching the contact list from a user registry may be advantageous in this context where the contacts are automatically supplied and may be unknown to the person initiating the communication. In addition, the relationship between the task management and the contact list can be used to decorate the contact listing with task context information. In the above example, the approval status for each approver listed in the contact list could be indicated by the contact either directly on the contact list, or through a pop-up or hover listing.

Once the management of a contact list is automated, many opportunities are available for heuristics to manage the presentation and organization of a contact. One type of management is frequency-based management. If the purchasing agent from above processes a lot of P.O. from the same division and chats with the division approver during the processing of each P.O., that person can be automatically added to the agent's contact list. If the agent goes several months without using a contact, the contact may be removed from the active list. Similarly, a most active group can be maintained that has a time sensitive list of the most used contacts. Usage may be aged out, for example, over the course of a few days. Thus, if a user is involved in a short term project, other members of the project will quickly percolate to the top of the contact list. When the project is over, they will settle down to the bottom.

The mechanism described above for application managed contact lists allows task context in the form of tags associated with contacts. It also may be used to allow the contact management process to establish a current task context of the user. Contacts can be dynamically grouped and ordered based on the current user task. For example, when the purchasing agent is in the approval stage of a task, a group of people frequently contacted in the past while in the approval stage of a task could be presented.

Context tags as well as manually entered tags can also be used for user initiated searching and grouping. For example the agent could search for all approver contacts and get a list of all contacts that are or have been presented in the approver role. Role tags can be automatically generated when a contact is moved from a task specific contact list to a general contact list—possibly due to frequency of use. Since the process management application builds the task centric contact list from process artifact fields that have role based semantics, use of a contact from the process management application may have an implicit role associated with it. In one embodiment, the act of using a contact in a specific role context forms a binding between the user, the contact, and the role.

Also, embodiments described herein for application managed contact lists provide a more effective framework for handling time sensitive tasks based primarily on the tags associated with contacts and improved where required by additional selection rules. For example, if the purchasing agent from above requires approval for a P.O., the algorithm may identify a P.O. manager called Joe, however, there are no guarantees that Joe will be online to have the necessary intellectual exchanges and approve the P.O. A backup or alternative P.O. manager with the required level to approve can be determined and added to the contact list. For instance, if Joe has a tag of “Required Approver (P.O. amount exceeds $500,000)” and happens to be offline, by searching existing tags and understanding the scope of power for the defined roles in the system, the algorithm can determine that “Tom Smith, Manufacturing Division CFO, Required Approver (P.O. amount exceeds $1,000,000)” can approve the P.O. and meet the necessary Service Level Agreements (SLAs).

A SLA describes a quality of service between a service provider and a consumer. In one example, a quality of service regarding a SLA may be measured by incident response time and time to resolution, for example, at a service desk. The incident response time is the time between the incident submission and the active work on the incident. The time to resolution is the time needed to resolve the incident. Hence, in one embodiment, a SLA is a contractual commitment to complete a business process within a set time parameter.

Alternatives or backups may be predetermined (e.g., Joe specifies a backup manager), determined (e.g., through searches and rules), or self-advertised (e.g., Ron tags himself as willing to approve purchase orders of Priority 1 if the respective P.O. manager is unavailable). In situations where alternatives don't exist or do not suffice, and some of the required parties are offline, the context sensitive contact list can be persisted and a notification related to the current work item can be triggered when some or all required parties are online. Other embodiments are also described below with specific reference to the corresponding figures.

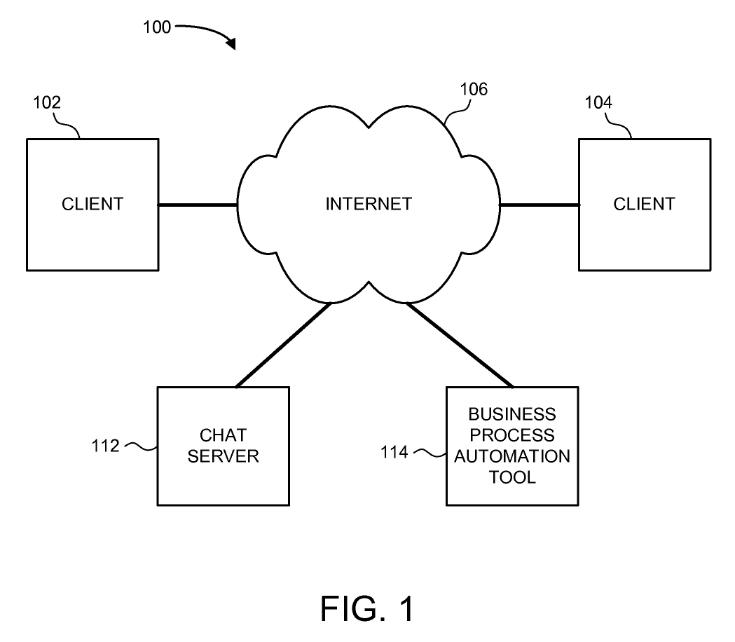

FIG. 1 depicts a block diagram of one embodiment of a network 100 to automate a business process. The network 100 includes clients 102 and 104 connected to an internet 106. A chat server 112 is also connected to the internet 106. The network 100 also includes a business process automation tool 114. Some embodiments may include fewer or more components to perform fewer or more operations.

The business process automation tool 114 facilitates a business process. The chat server 112 facilitates a communication between clients 102 and 104. In some embodiments, the clients 102 and 104 are connected to the internet 106 via a wireless connection. In other embodiments, the clients 102 and 104 are connected within a local area network (LAN) which is then connected to the internet 106. In some embodiments, the chat server 112 may facilitate a communication of one or more of the clients 102 and 104 corresponding to a business process of the business process automation tool 114. Although the internet 106 is shown and referenced herein, other embodiments may use other types of networks such as a local area network.

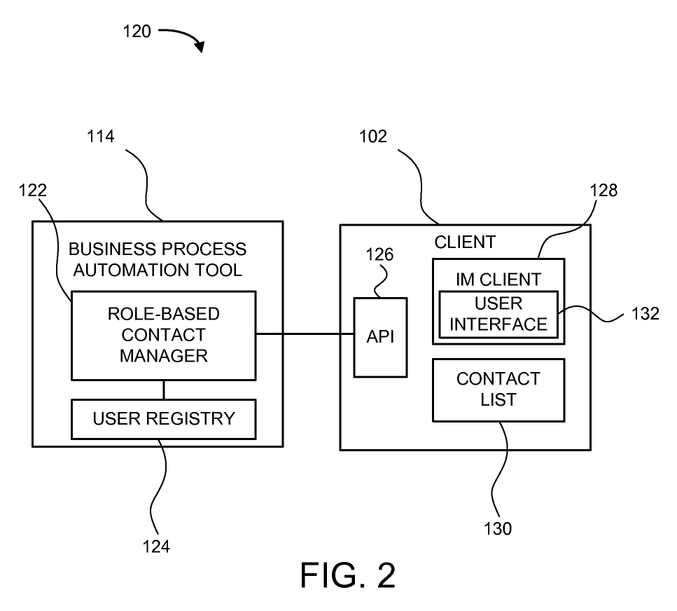

FIG. 2 depicts a block diagram of one embodiment of a business process automation system 120 for implementation on the network 100 of FIG. 1. The business process automation system 120 of FIG. 2 includes a business process automation tool 114 and a client 102. Some embodiments may include fewer or more components to perform fewer or more operations.

The illustrated business process automation tool 114 includes a role-based contact manager 122 and a user registry 124. In some embodiments, the role-based contact manager 122 is coupled to the user registry 124. The user registry 124 provides user data to the role-based contact manager 122. In one embodiment, the user registry 124 stores user information corresponding to potential contacts relevant to an operation of the role-based contact manager 122. In another embodiment, the role-based contact manager 122 manages data generated by the user registry 124. In some embodiments, the contact manager 122 dynamically arranges a list of contacts that are relevant to an active task of a user. A task may be defined as one or more forms or screens and logic to connect them. In other embodiments, the contact manager 122 manages a contact list based on the task a user currently has active in a process management environment. The contact list may be built based on the roles and interested parties for the current task and may change with both the state of the task and the activity level of the task. The contact manager 122 may also control the order of the contacts on the contact list based on frequency of communication with the individual contacts. In some embodiments, contacts may be moved by the contact manager 122 into a permanent status within the contact list.

The illustrated client 102 includes an application programming interface (API) 126. The client 102 also includes an instant messaging (IM) client 128 and a contact list 130. In one embodiment, the API 126 interfaces with the role-based contact manager 122. The API 126 also facilitates an interaction between the business process automation tool 114 and the client 102. More specifically, in some embodiments, the API 126 facilitates a transfer of data between the role-based contact manager 122 and the IM client 128.

In one embodiment, the IM client 128 includes a user interface 132. The user interface 132 facilitates user interaction with the client 128. The user interface 132 may be a graphical user interface (GUI) or a tactile interface such as a mouse or keyboard. Other embodiments may implement other types of interface technologies to facilitate the interaction of a user with the IM client 128 through the user interface 132.

In some embodiments, the contact list 130 includes a list of possible contacts communicated by the business process automation tool 114. In one embodiment, the possible contacts are compiled in order of relevance with respect to an active task of a user interfacing with the client 102 via the user interface 132. Other embodiments may organize the possible contacts in another manner.

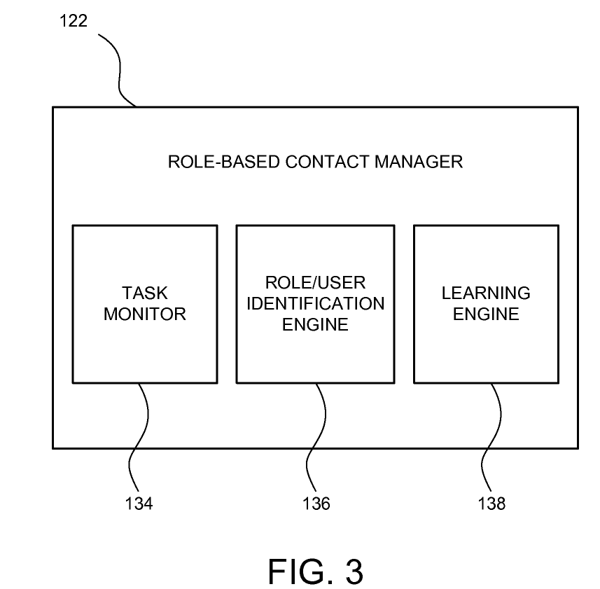

FIG. 3 depicts a block diagram of one embodiment of the role-based contact manager 122 of the business process automation tool 114 of FIG. 2. In some embodiments, the role-based contact manager 122 includes a task monitor 134. The role-based contact manager 122 also includes a role/user identification engine 136. The role-based contact manager 122 also includes a learning engine 138. Some embodiments of the role-based contact manager 122 may include fewer or more functional blocks to perform fewer or more operations.

In one embodiment, the task monitor 134 monitors an active task of a user within the business process automation tool 114. In some embodiments, the task monitor 134 performs a text analysis. In some embodiments, the task monitor 134 is configured to analyze documents that pertain to the active task to locate key words and/or phrases to relate a role to the task. In other embodiments, the task monitor 134 compares the source of the task with past roles related to the same or similar sources. For example, if an active task is a project from a specific department, the task monitor 134 might recall roles, contacts, or information relating to a previous task from the same or a similar department. Additionally, the task monitor 134 may associate the information to the current project. In other embodiments, the task monitor 134 uses other forms of monitoring the active task to provide or derive contact association information. For example, the task monitor 134 may analyze subject lines of emails, carbon copy recipients, sender information, or project supervisor information to accomplish or refine the task monitoring and analysis.

In one embodiment, the role-based contact manager 122 also includes a role/user identification engine 136. In some embodiments, the role/user identification engine 136 associates a user with information compiled by the task monitor 134. In other embodiments, the role/user identification engine 136 associates a contact with role information from a previous communication about the active task. The role/user identification engine 136 generates a list of task relevant contacts. If the task relevant contacts are currently unavailable for communication, the role/user identification engine 136 stores the list. In some embodiments, the role/user identification engine 136 subsequently displays a notification to a user in response to detection of a task relevant contact becoming available to the user for communication.

The role-based contact manager 122 also includes a learning engine 138. In one embodiment, the learning engine 138 controls the order of the contacts in a list of contacts based on priority criteria. In particular, the learning engine 138 may dynamically manage the list of contacts based on both the activity and state of the current task. In some embodiments, the learning engine 138 organizes the list of contacts with respect to a frequency of communication with the contact. In another embodiment, the learning engine 138 removes old or unused contacts from the list of contacts. In some embodiments, the priority criteria that govern the learning engine 138 are defined by the user. For example, the learning engine 138 may order the list of relevant contacts by geographic proximity to the user or in order of access level. Other embodiments may implement other parameters for management of the contact list.

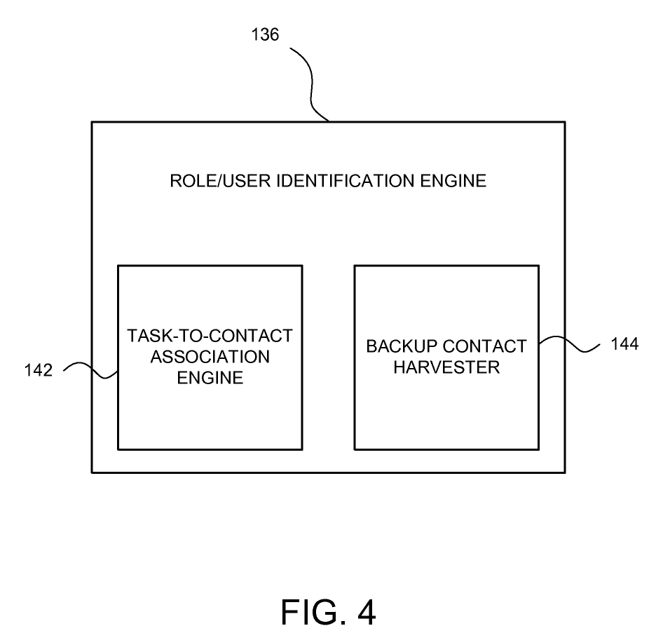

FIG. 4 depicts a block diagram of one embodiment of the role/user identification engine 136 of the role-based contact manager 122 of FIG. 3. The role/user identification engine 136 includes a task-to-contact association engine 142 and a backup contact harvester 144. Some embodiments may include fewer or more components to perform fewer or more operations.

In one embodiment, the task-to-contact association engine 142 associates the active task to a contact. Additionally, the task-to-contact association engine 142 may recognize an association between a task and a specific contact through the list of roles that have been determined to be relevant to the current task. In one embodiment, the task-to-contact association engine 142 stores a relation between a task and a contact when a user communicates with the contact regarding the task. For example, if the user communicates with an individual or group through email, the association engine 142 may store a list of relevant contacts to be used to generate a full list of task relevant contacts harvested from multiple sources. In another embodiment, the task-to-contact association engine 142 generates a connection between a task and a contact when defined by the user.

In one embodiment, a button is created in a field containing contact information relevant to a state of an active task. The button may facilitate initiation of a chat session with the contact. In other embodiments, the button may be a link, pop-up, or drop-down menu, or another form of facility for initiating a chat session with the task relevant contact.

In other embodiments, a relationship is generated upon determination that a threshold based on communication time is reached. In some embodiments, the threshold may be the number of times communication has been established with a contact or a cumulative amount of time that the user has been in communication with the contact over a period. In some embodiments, a relationship between the task and the contact is generated upon determination that a frequency of communication requirement has been met. Other embodiments, may implement other parameters for establishment of task-to-contact association.

In one embodiment, the backup contact harvester 144 of the role/user identification engine 136 generates a list of secondary or backup contacts. In one embodiment, the backup contact harvester 144 generates a secondary task relevant contact associated with or similar to a primary task relevant contact. In another embodiment, the backup contact harvester 144 harvests a secondary task relevant contact in response to a determination that the primary task relevant contact is not available for communication. In some embodiments, the backup contact harvester 144 generates a secondary task relevant contact in response to a determination that the primary task relevant contact may not satisfy the needed role for the task. As an example, if a purchasing agent needs approval on a purchase order for server hardware, then the purchasing agent may be provided with a primary contact, as well as a secondary contact generated by the backup contact harvester 144. If the primary financial approver contact is certified to approve amounts up to $10,000, and a secondary financial approver contact is certified to approve amounts up to $100,000, and the order for server hardware is for $50,000, the purchasing agent will communicate with the secondary contact for approval. In some embodiments, the backup contact harvester 144 may generate more than one secondary contact.

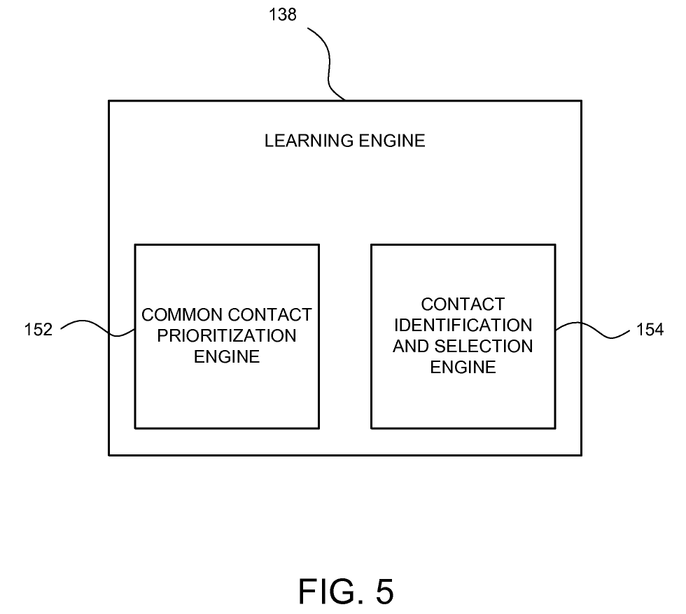

FIG. 5 depicts a schematic diagram of one embodiment of the learning engine 138 of the role-based contact manager 122 of FIG. 3. The learning engine 138 includes a common contact prioritization engine 152 and a contact identification and selection engine 154. Some embodiments may include fewer or more components to perform fewer or more operations.

In some embodiments, the common contact prioritization engine 152 tracks a frequency of communication with a contact over an amount of time. In another embodiment, the common contact prioritization engine 152 tracks a contact that is related to two or more active tasks or roles. In some embodiments, the contact prioritization engine 152 tracks repeated communications with a contact over various projects, past and present. In some embodiments, the common contact prioritization engine 152 tracks the time since last communication for a contact. For example, if a contact is used once and then communication is not made with the contact for a predetermined time period, the common contact prioritization engine 152 will settle the contact lower in rank on a list of common contacts. Other embodiments of the prioritization engine 152 track other parameters to organize the list of contacts.

The contact identification and selection engine 154 of the learning engine 138 facilitates selection of a contact by a user. In some embodiments, the contact identification and selection engine 154 detects interested parties for communication. For example, if a purchasing agent wishes to fill a purchase order that needs to be approved by a financial approver, and a supervisor wishes to be notified upon approval of the purchase order, the contact identification and selection engine 154 may automatically add the supervisor to a notification list and/or the contact list. In other embodiments, the contact identification and selection engine 154 limits the user's list of available contacts to view. In another embodiment, the contact identification and selection engine 154 accesses contacts that are within the user's access rights. Other embodiments of the contact identification and selection engine 154 detect a status identifier related to an active task and facilitate access to contacts that would be otherwise restricted due to limited access rights. For example, if the active task is marked high priority or urgent, contacts would be made available that would be unavailable without a priority status identifier.

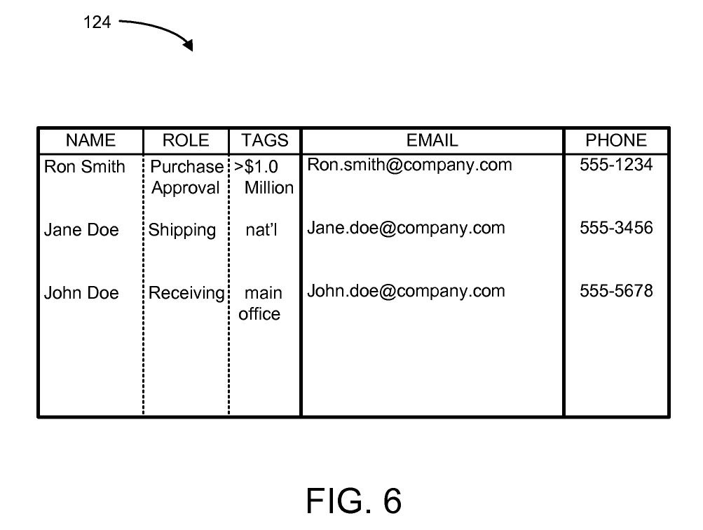

FIG. 6 depicts one embodiment of the user registry 124 of the business process automation tool 102 of FIG. 2. In general, the user registry 124 stores contact information. In some embodiments, the user registry 124 stores all of the contact information for all known contacts. Additionally, the contact information in the user registry 124 may be shared among many applications. In the illustrated embodiment, the user registry 124 contains a name and role of a relevant contact. Alternatively, in some embodiments, the role of a contact listed in the user registry 124 may be inferred from how a task references a user. For example, a role of a user as an “approver” may be inferred from a listing of the user's name in the approver field of a form. In other embodiments, more or less contact information may be stored in the user registry 124. The user registry 124 also includes tags that further detail task relevant contact information. In another embodiment, contact tags are stored in a separate registry to prevent altering existing data. Further information depicted in the user registry 124 includes email and phone contact information. In some embodiments, less or more information may be displayed in the user registry 124. In some embodiments, the information may be stored in a plurality of registries. In some embodiments, the user registry 124 is user configurable. In other embodiments, the user registry 124 displays at least one portion of the task and contact relevant information via a popup or hover list. Other embodiments of the user registry 124 utilize other display types and arrangements to display the contact information. The user registry 124 may include less or more contact information to provide less or more functionality.

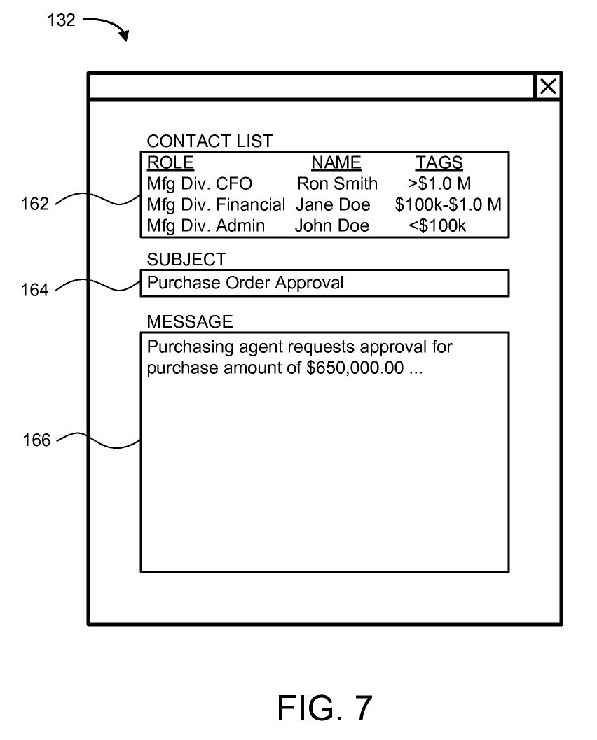

FIG. 7 depicts a schematic diagram of one embodiment of a user interface 132 for implementation with the business process automation tool 102 of FIG. 2. In one embodiment, the user interface 132 includes a contact list window 162. The user interface 132 also includes a subject line 164 and a message window 166. Although FIG. 7 shows a specific orientation of the components of the user interface 132, other embodiments may utilize different arrangements. Other embodiments may also include fewer or more windows or functional components of the user interface 132. In some embodiments, the user interface 132 includes menus to select features and functions of the user interface 132. In one embodiment, the user interface 132 includes a video communication window. Another embodiment allows the user to drag the user interface 132 or windows 162, 164, and 166 into a custom arrangement. Other embodiments of the user interface 132 incorporate different styles and types of interface configurations. In some embodiments, the user interface 132 includes multiple chat windows 166 to facilitate more than one chat communication simultaneously. In another embodiment, the message window 166 of the user interface 132 facilitates conference or group chat communication.

In one embodiment of the user interface 132, the user input into the subject line 164 is tagged with metadata which is used to further refine the contact list in the contact list window 162. In some embodiments of the user interface 132, the contact list 162 is configured to omit a contact to which the user does not have a respective access right. In another embodiment, the contact list 162 includes a convention to display and lock a contact to which the user does not have the respective access rights. In some embodiments, the contact list window 162 of the user interface 132 is configured to display multiple contacts. For example, FIG. 7 illustrates the contact list window 162 as having three individual contacts from the manufacturing division. Each of the contacts in the contact list window 162 is shown with a respective name and tag. In the illustrated embodiment, the tags detail the approval limits for each specific contact.

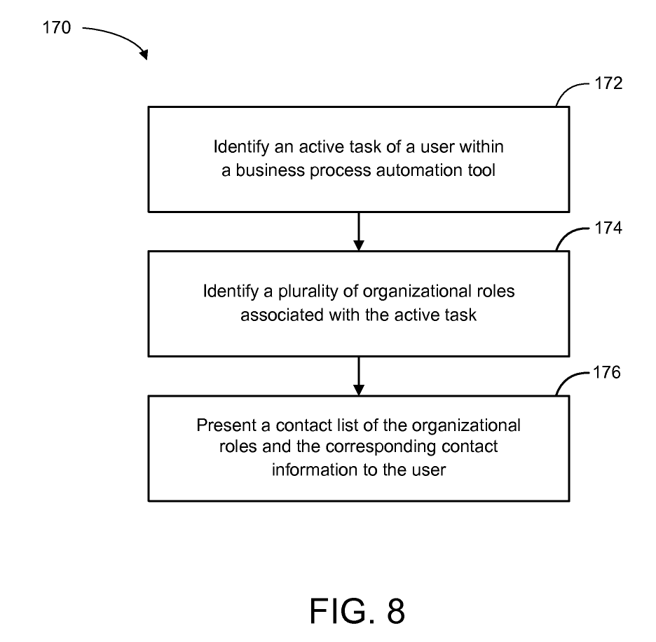

FIG. 8 depicts a flow chart diagram of a contact list management method 170 for implementation with the business process automation tool 102 of FIG. 2. The method 170 includes a task monitor 134 to identify 172 an active task of a user within a business process automation tool 114. The illustrated method 170 also accesses a task-to-contact association engine 142 to identify 174 a plurality of roles associated with the active tasks. Each of the roles is associated with corresponding contact information. The method 170 also implements a user interface 132 to present 176 a contact list of the roles and the corresponding contact information to the user.

In one embodiment, IM contact list management functionality is added into a process automation tool such as the Maximo® process automation tool. The contact list is generated based on the roles and interested parties for the current task and changes dynamically with both the state and activity level of the task. Some embodiments include a learning engine that controls display order within the contact list and can move frequently used contacts into more permanent sections of the task list, as well as age out contacts that go unused.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer useable storage medium to store a computer readable program that, when executed on a computer, causes the computer to perform operations comprising:
identify an active task of a user within a business process automation tool;
identify a plurality of roles associated with the active task, wherein each of the roles is associated with corresponding contact information; and
present a contact list of the roles and the corresponding contact information to the user.

2. The computer program product of claim 1, wherein the computer readable program that, when executed on a computer, causes the computer to perform an operation to manage the contact list via a learning algorithm to dynamically arrange the roles within the contact list based on frequencies of contact between the user and other users associated with the corresponding contact information.

3. The computer program product of claim 1, wherein the computer readable program that, when executed on a computer, causes the computer to perform an operation to indicate an availability status for each role in the contact list.

4. The computer program product of claim 3, wherein the computer readable program that, when executed on a computer, causes the computer to perform operations comprising:
save the contact list in response to determination that a relevant contact is unavailable; and
provide notification in response to detection of the relevant contact becoming available.

5. The computer program product of claim 1, wherein the computer readable program, when executed on the computer, causes the computer to perform an operation to display a descriptive tag for each role within the contact list.

6. The computer program product of claim 1, wherein the computer readable program, when executed on the computer, causes the computer to perform an operation to present the contact information within the contact list to the user according to access rights of the user.

7. The computer program product of claim 1, wherein the computer readable program that, when executed on a computer, causes the computer to perform an operation to assign a role to a potential contact based on a semantic analysis of a previous interaction between the user and the potential contact.

8. A system comprising:
a computer;
a business process automation tool stored and configured to operate on the computer, the business process automation tool to manage a business process;
a role-based contact manager coupled to the business process automation tool, the role-based contact manager to identify a plurality of roles associated with an active task within the business process automation tool, wherein each of the roles is associated with corresponding contact information, and to generate a contact list of the roles and the corresponding contact information.

9. The system of claim 8, wherein the role-based contact manager is further configured to send a contact list to a client coupled to the computer to display the contact list in conjunction with a text chat client.

10. The system of claim 8, wherein the role-based contact manager comprises a task monitor to monitor a current task of the client.

11. The system of claim 8, wherein the role-based contact manager comprises a learning engine to analyze a previous interaction with the potential contacts and to dynamically reorganize the list of contacts, wherein the learning engine comprises:
a common contact prioritization engine to track a communication frequency with a contact; and
a contact identification and selection engine coupled to the common contact prioritization engine, the contact identification and selection engine to facilitate selection of a corresponding contact.

12. The system of claim 8, wherein the role-based contact manager is coupled to a user registry to store contact information to enrich the contact list.

13. The system of claim 8, wherein the role-based contact manager is configured to order the contact list based on prioritization criteria.

14. The system of claim 13, wherein the prioritization criteria comprises a frequency of communication with the contact.

15. The system of claim 8, wherein the role-based contact manager comprises a role/user identification engine to identify a potential contact associated with one of the roles based on the active task.

16. The system of claim 15, wherein the role/user identification engine further comprises:
a task-to-contact association engine to associate the active task with a contact; and
a backup contact harvester coupled to the task-to-contact association engine, the backup contact harvester to generate a list of backup contacts.

17. A contact list management method comprising:
identifying an active task of a user within a business process automation tool;
identifying a plurality of roles associated with the active task, wherein each of the roles is associated with corresponding contact information; and
generating a contact list of the roles and the corresponding contact information.

18. The method of claim 17, further comprising at least one operation of a plurality of operations, wherein the plurality of operations comprises:
binding a contact to a role within a user contact list;
generating a contact list of alternate task relevant contacts;
managing the contact list via a learning algorithm;
saving the contact list in response to a determination that a relevant contact is unavailable; and
providing notification in response to a detection of a relevant contact becoming available.

19. The method of claim 18, wherein managing the contact list via the learning algorithm further comprises dynamically arranging the roles within the contact list based on frequencies of contact between the user and other users associated within the corresponding contact information.

20. The method of claim 17, further comprising indicating an availability status for each role in the contact list.
